(19) United States
(12) Patent Application Publication
(10) Pub. No.: US 2023/0137994 A1
(43) Pub. Date: May 4, 2023

(54) DUAL-PURPOSE GREETING CARD AND WASHCLOTH

(71) Applicant: Laura Wittig, Seattle, WA (US)

(72) Inventor: Laura Wittig, Seattle, WA (US)

(21) Appl. No.: 17/976,921

(22) Filed: Oct. 31, 2022

Related U.S. Application Data
(60) Provisional application No. 63/285,846, filed on Dec. 3, 2021.
(60) Provisional application No. 63/273,992, filed on Oct. 31, 2021.

(51) Int. Cl. G09F 23/00; A47L 13/16; A47L 13/42; G09F 1/04

(52) U.S. Cl. CPC G09F 23/00; A47L 13/16; A47L 13/42; G09F 1/04

(57) ABSTRACT

A dual-purpose greeting card and dishcloth is provided, comprising one or more layers of absorbent, washable, reusable, recyclable, and biodegradable fabric material, wherein the dual-purpose greeting card and dishcloth further comprises: a) a first surface defining an inner surface configured to enable a user to write a message thereon; and b) a second surface arranged opposite to the first surface, wherein the second surface defines an outer surface comprising one or more illustrations. The fabric material may comprise cellulose, cotton, and/or microfibers and is wettable with a liquid, particularly water and/or a cleaning agent. In other embodiments, the dual-purpose greeting card comprises a substantially rectangular shape, a pair of lateral sides, a pair of longitudinal sides extending between the lateral sides, and a fold line arranged substantially parallel to the longitudinal sides and that divides the lateral sides into two flaps.

### CLAIM OF PRIORITY

The present disclosure claims priority to U.S. Provisional Pat. Application No. 63/273,992, filed on Oct. 31, 2021, and U.S. Provisional Pat. Application No. 63/285,846, filed on Dec. 3, 2021, both of which are fully incorporated herein by reference.

### FIELD OF THE INVENTION

The present disclosure relates to a dual-purpose greeting card that is suitable for use as a dishcloth for wiping a surface.

### BACKGROUND

During any celebration or occasion, sending and receiving cards has been a way to express our love and gratitude. In a year, thousands of cards are being exchanged leading to the generation of the massive amount of carbon footprint from the paper and other non-biodegradable and non-recyclable materials. One drawback of cards is that they are typically exchanged and enjoyed for a very brief time and then typically thrown away and thus become useless only after a single use, which is undesirable.

Accordingly, there is a need for a greeting card that can be eco-friendly.

### SUMMARY

To address the foregoing problems, in whole or in part, and/or other problems that may have been observed by persons skilled in the art, the present disclosure provides compositions and methods as described by way of example as set forth below.

A dual-purpose greeting card and dishcloth is provided, comprising one or more layers of absorbent, washable, reusable, recyclable, and biodegradable fabric material, wherein the dual-purpose greeting card and dishcloth further comprises:
a) a first surface defining an inner surface configured to enable a user to write a message thereon; and
b) a second surface arranged opposite to the first surface, wherein the second surface defines an outer surface comprising one or more illustrations.
In some embodiments, the fabric material comprises cellulose, cotton, and/or microfibers. In other embodiments, the fabric material is wettable with a liquid, particularly wherein the liquid is water and/or a cleaning agent. In other embodiments, the one or more illustrations are printed, painted, or dyed onto the outer surface.

In other embodiments, the dual-purpose greeting card comprises a substantially rectangular shape, a pair of lateral sides, a pair of longitudinal sides extending between the lateral sides, and a fold line arranged substantially parallel to the longitudinal sides and that divides the lateral sides into two flaps. In other embodiments, when the dual-purpose greeting card and dishcloth is folded along the fold line, the first surface is divided into two portions that are arranged facing each other. In other embodiments, the fold line is a center line dividing the dual-purpose greeting card and dishcloth into two equal halves. In other embodiments, the fold line is an offset from the center line dividing the dual-purpose greeting card and dishcloth into two unequal parts.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates a perspective view of a greeting card disposed in a folded configuration;

FIG. 2 illustrates a top view of the greeting card depicting an inner surface of the greeting card; and

FIG. 3 illustrates a top view of the greeting card depicting an outer surface of the greeting card.

### DETAILED DESCRIPTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

### Dual-Purpose Greeting Card

A dual-purpose greeting card and dishcloth is provided, comprising one or more layers of absorbent, washable, reusable, recyclable, and biodegradable fabric material, wherein the dual-purpose greeting card and dishcloth further comprises:
a) a first surface defining an inner surface configured to enable a user to write a message thereon;
b) a second surface arranged opposite to the first surface, wherein the second surface defines an outer surface comprising one or more illustrations.
In some embodiments, the fabric material comprises cellulose, cotton, and/or microfibers. In other embodiments, the fabric material is wettable with a liquid, particularly wherein the liquid is water and/or a cleaning agent. In other embodiments, the one or more illustrations are printed, painted, or dyed onto the outer surface.

In other embodiments, the dual-purpose greeting card comprises a substantially rectangular shape, a pair of lateral sides, a pair of longitudinal sides extending between the lateral sides, and a fold line arranged substantially parallel to the longitudinal sides and that divides the lateral sides into two flaps. In other embodiments, when the dual-purpose greeting card and dishcloth is folded along the fold line, the first surface is divided into two portions that are arranged facing each other. In other embodiments, the fold line is a center line dividing the dual-purpose greeting card and dishcloth into two equal halves. In other embodiments, the fold line is an offset from the center line dividing the dual-purpose greeting card and dishcloth into two unequal parts.

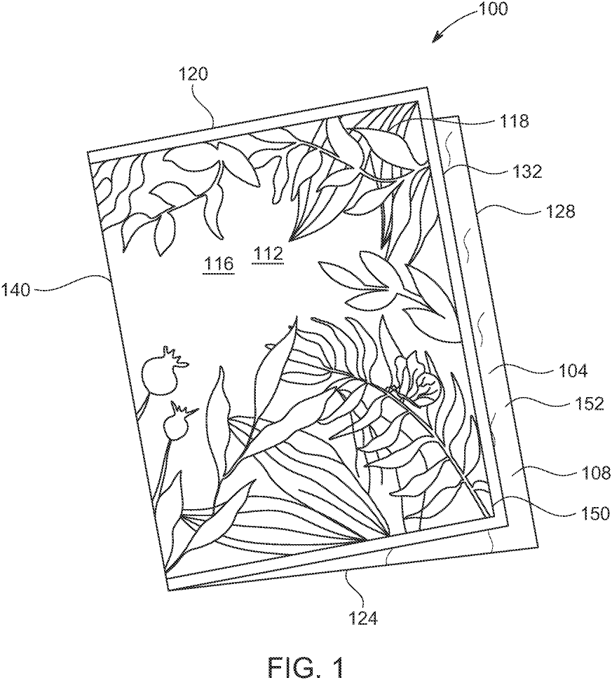

Referring to FIGS. 1 to 3, a dual-purpose greeting card and dishcloth 100 (hereinafter referred to as card 100) is shown, suitable for being used as a greeting card as well as a dishcloth for cleaning or wiping a surface. The card 100 is made of absorbent fabric material, for example, washable cellulosic fabric, and can be reused multiple times and is easy recycled. In an embodiment, the card 100 may include multiple layers of different materials. The fabric material may include a mixture of cellulose, cotton, and microfibers to facilitate an absorption of liquid and/or removal of dirt from the surface. In an embodiment, the card 100 is made of biodegradable material.

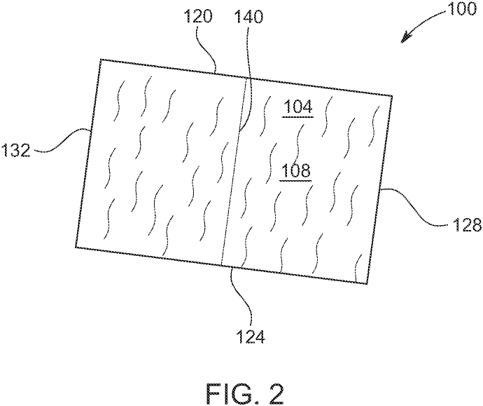

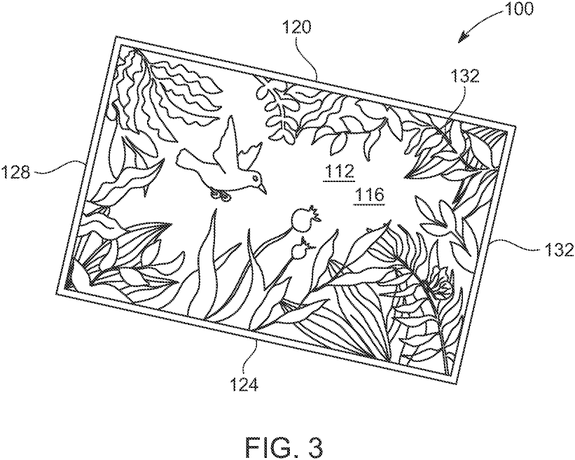

The card 100 includes a first surface 104 (shown in FIGS. 1 and 2) defining an inner surface 108 of the card 100, and a second surface 112 (shown in FIGS. 1 and 3) arranged opposite to the first surface 104. The second surface 112 defines the outer surface 116 of the card 100. The first surface 104 generally includes a white texture to facilitate the writing of a message by a user, while the second surface 112 includes one or more decorative illustrations 118 to augment the aesthetic look and appeal of the card. In an embodiment, the second surface 112 of the card 100 may be printed, painted, dyed, etc., to provide the illustrations 118 on the card 100. In some embodiments, the second surface 112 of the card 100 is defined by a first layer made of materials on which illustrations can be provided easily, while the first surface 104 is defined by a second layer made of materials having dirt removal and wiping properties.

As shown in FIGS. 2 and 3, the card 100 includes a substantially rectangular shape having a pair of lateral sides 120, 124 and a pair of longitudinal sides 128, 132 extending between the lateral sides 120, 124. Also, the card 100 includes a fold line 140 arranged substantially parallel to the longitudinal sides 128, 132 and that divides the lateral sides 120, 124 into two parts. Accordingly, a fold line 140 divides the card 100 into two portions 150, 152 that define the two flaps of the card 100 when the card 100 is folded along the fold line 140 (as shown in FIG. 1). The card 100 is folded along the fold line such that the two portions of the first surface 104 are arranged facing each other. In such an arrangement, the second surface 112 of the card 100 defines the outer surfaces of the flaps. In an embodiment, the fold line 140 is a center line dividing the card 100 into two equal halves. In an embodiment, the fold line 140 may be offset from the center line of the card 100.

For using the card 100 as dishcloth, the flaps are straightened, and the surface is wiped. In some scenarios, the card 100 can be wet with a liquid, such as water, cleaning agent, for cleaning the surface. As the card 100 is made of fabric containing cellulose, the card can be washed to remove the dirt and can be reused for cleaning.

The application and the advantages of the card 100 is now explained. The card 100 facilitates the purpose of gifting and creates special movements for loved ones. In addition, the card 100 is used for cleaning. Further, the card 100 may be hand washed and dried or may be washed in a washing machine, a dishwasher, or a tumble dry technique to facilitate the cleaning and drying of the card 100. In addition, the biodegradable nature of the cellulose facilitates the biodegradation of the card 100 and eliminates the chances of any pollution of the landfills while decomposing the card 100.

### General Definitions

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ± 100%, in some embodiments ± 50%, in some embodiments ± 20%, in some embodiments ± 10%, in some embodiments ± 5%, in some embodiments ± 1%, in some embodiments ± 0.5%, and in some embodiments ± 0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A dual-purpose greeting card and dishcloth comprising one or more layers of absorbent, washable, reusable, recyclable, and biodegradable fabric material, wherein the dual-purpose greeting card and dishcloth further comprises:
a) a first surface defining an inner surface configured to enable a user to write a message thereon;
b) a second surface arranged opposite to the first surface, wherein the second surface defines an outer surface comprising one or more illustrations.

2. The dual-purpose greeting card and dishcloth of claim 1, wherein the fabric material comprises cellulose, cotton, and/or microfibers.

3. The dual-purpose greeting card and dishcloth of claim 1, wherein the fabric material is wettable with a liquid.

4. The dual-purpose greeting card and dishcloth of claim 1, wherein the liquid is water and/or a cleaning agent.

5. The dual-purpose greeting card and dishcloth of claim 1, wherein the one or more illustrations are printed, painted, or dyed onto the outer surface.

6. The dual-purpose greeting card and dishcloth of claim 1, comprising a substantially rectangular shape, a pair of lateral sides, a pair of longitudinal sides extending between the lateral sides, and a fold line arranged substantially parallel to the longitudinal sides and that divides the lateral sides into two flaps.

7. The dual-purpose greeting card and dishcloth of claim 6, wherein when the dual-purpose greeting card and dishcloth is folded along the fold line the first surface is divided into two portions that are arranged facing each other.

8. The dual-purpose greeting card and dishcloth of claim 7, wherein the fold line is a center line dividing the dual-purpose greeting card and dishcloth into two equal halves.

9. The dual-purpose greeting card and dishcloth of claim 7, wherein the fold line is an offset from the center line dividing the dual-purpose greeting card and dishcloth into two unequal parts.
